(19) United States
(12) Patent Application Publication
(10) Pub. No.: US 2022/0004828 A1
(43) Pub. Date: Jan. 6, 2022

(54) CONFIGURING COLOR CONCENTRATIONS BASED ON A WHITE-POINT OF PRINT MATERIAL

(71) Applicant: Hewlett-Packard Development Company, L.P., Spring, TX (US)

(72) Inventors: Donald J. Fasen, Boise, ID (US); Brian Mayer, Boise, ID (US)

(73) Assignee: Hewlett-Packard Development Company, L.P., Spring, TX (US)

(21) Appl. No.: 17/298,613

(22) PCT Filed: Jul. 18, 2019
(86) PCT No.: PCT/US2019/042343

§ 371 Date: May 31, 2021

(51) Int. Cl. G06K 15/02; G06F 3/12

(52) U.S. Cl. CPC G06K 15/027; G06F 3/1253; G06F 3/1208

(57) ABSTRACT

Aspects of the present disclosure relate to color printing calibration. In a particular example, an apparatus includes a media sensor and a formatter. The media sensor may collect spectral data from light reflected off a print material. The media sensor may include a light source to illuminate a portion of the print material, a diffractor to diffract light reflected off of the print material, and a photo-detector to obtain the spectral data from the light reflected off the print material. The formatter may identify a white-point of the print material using the spectral data and configure color concentrations in the apparatus based on the identified white-point of the print material.

### BACKGROUND

Color calibration in color printers may improve the consistency of color output over time, and the consistency of color output from printer to printer, or page to page, as well. The color calibration for different printing temperatures may also impact the consistency of color output. The parameters that can lead a printer to deliver colors differently than expected are manifold and may include humidity, temperature variations in the print heads, or slightly different substrate chemical properties, among many others.

### BRIEF DESCRIPTION OF FIGURES

Various examples may be more completely understood in consideration of the following detailed description in connection with the accompanying drawings, in which:

FIG. 1 illustrates an example apparatus for configuring color concentrations based on a white-point of print material, consistent with the present disclosure;

FIG. 2 further illustrates an example apparatus for configuring color concentrations based on a white-point of print material, consistent with the present disclosure; and

FIG. 3 illustrates an example method for configuring color concentrations based on a white-point of print material, consistent with the present disclosure.

While various examples discussed herein are amenable to modifications and alternative forms, aspects thereof have been shown by way of example in the drawings and will be described in detail. It should be understood, however, that the intention is not to limit the disclosure to the particular examples described. On the contrary, the intention is to cover all modifications, equivalents, and alternatives falling within the scope of the disclosure including aspects defined in the claims. In addition, the term “example” as used throughout this application is only by way of illustration, and not limitation.

### DETAILED DESCRIPTION

Many printing devices are calibrated, not only when printing supplies are replenished, or when different materials are to be printed on, but over various intervals of time as well. Additionally, because the characteristics of the printing materials may change, for instance the light reflective characteristics of the printing materials may be different, or the amounts of color inks put down increase, the end result may be appreciated to be a color print different from those previously made on that printer.

In some examples, calibrating a color printer involves establishing how much of each reference color, such as Cyan (C), Magenta (M), Yellow (Y) and Black (K), are in a printed strip. Additionally, a reading of the printing material white point may be determined. As used herein, a white point refers to or includes a print material's whitest point, i.e. the color of the color space that is closest to white, although a non-printed region of a corresponding medium does not need to be white. The print material's white point may be approximately coincident with the unprinted material's color. The white point of the printing material may impact the final color and/or quality of print and therefore impact the calibration of the printing device.

In accordance with the present disclosure, an apparatus for configuring color concentrations based on a white-point of print material includes a media sensor and a formatter. The media sensor may collect spectral data from light reflected off the print material. The media sensor may include a light source to illuminate a portion of the print material, a diffractor to diffract light reflected off of the print material, and a photo-detector to obtain the spectral data from the light reflected off the print material. The formatter may identify a white-point of the print material using the spectral data and configure color concentrations in the apparatus based on the identified white-point of the print material.

In various examples, the photo-detector includes an array of photodiodes, and the diffractor includes a prism. In such examples, the array of photodiodes may detect an intensity of light from each spectral bin diffracted from the prism. Additionally and/or alternatively, the diffractor may include a diffraction grating. As used herein, diffraction grating refers to or includes a component with a periodic structure that splits and diffracts light into several beams traveling in different directions or spectral bins. In some examples, the media sensor may determine a type of print material used by the apparatus, and collect a plurality of light intensity readings from light reflected off the print material. Accordingly, the formatter may configure the color concentrations based on the white-point of the identified type of print material.

In accordance with the present disclosure, color concentrations may be configured based on a white-point of print material. The printing device may include a media type sensor to determine the print mode to be used for an associated media type. The print mode may specify the process speed, transfer voltages and fuser temperature control to be used for quality printing. Additionally, the media sensor may also incorporate a photo-diode array for detecting media texture, surface roughness and gloss. Moreover, the media sensor may include a spectral density capability that may be used to determine the processing speed, transfer speed and fusing speed for the associated media type. The spectral information from the media sensor may be used to determine the white-point for the media. Accordingly, color concentrations for the printing device may be adjusted for the print material's white-point to improve color accuracy for a wide range of material colorations.

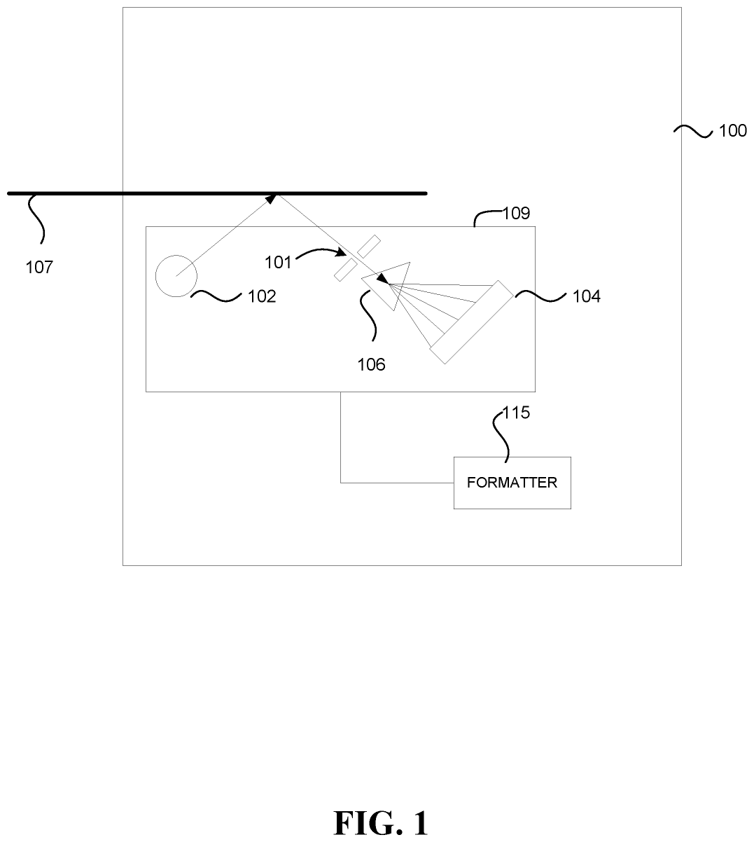

Turning now to the figures, FIG. 1 illustrates an example apparatus for configuring color concentrations based on a white-point of print material, consistent with the present disclosure. As illustrated in FIG. 1, the apparatus 100 includes a media sensor 109 to determine a type of print material 107 used by the apparatus 100 and to collect a plurality of light intensity readings from light reflected off the print material. For instance, the media sensor 109 may include a light source 102 to illuminate a portion of the print material 107, a diffractor 106 to diffract light reflected off of the print material, and a photo-detector 104 to obtain the plurality of light intensity readings from the light reflected off the print material 107. Additionally, the apparatus 100 may include a formatter 115 to identify a white-point of the print material 107 using the plurality of light intensity readings and to configure color concentrations in the apparatus based on the identified white-point of the print material.

The apparatus 100 may apply the white-point correction to a plurality of different media types. Although FIG. 1 illustrates the print material 107 as a sheet, the print material may be a substance for three-dimensional printing. For instance, print material 107 may be a polymer, a powder. As non-limiting examples, the print material may be acrylonitrile butadiene styrene (ABS), polylactic acid (PLA), polyvinyl alcohol (PVA), Nylon, High-density polyethylene (HDPE), polyethylene terephthalate (PETT), wood filament, metal filament, carbon fiber, flexible filament, and conductive filament, and thermal paper, and a sintering powder, among others. Responsive to the media sensor 109 determining the print material 107 is a three-dimensional printing substance, the formatter 115 may identify the white-point of the three-dimensional printing substance. In such examples, the formatter 115 may retrieve from a network-accessible table (not illustrated in FIG. 1), a color table including the color concentrations to be applied to the three-dimensional printing substance, based on the identified white-point. As used herein, the color table refers to or includes a database or lookup table that includes concentrations of colors to be applied at different white-points to achieve an accurate color print. Additionally and/or alternatively, the formatter 115 may generate a customized color table including the color concentrations to be applied to the three-dimensional printing substance, based on the identified white-point. Similarly, responsive to the media sensor determining the print material 107 is a two-dimensional printing surface, the formatter 115 may identify the white-point of the two-dimensional printing surface. As with three-dimensional printing substances, the formatter 115 may retrieve from a network-accessible table, a color table including the color concentrations to be applied to ink printed on the two-dimensional printing surface, based on the identified white-point. As such, the various color tables may be stored outside of apparatus 100, such as in a network-accessible database.

In various examples, the formatter 115 may configure color concentrations in the apparatus 100 based on the identified white-point of the print material 107. For instance, the formatter 115 may select a color table among a plurality of color tables based on the identified white-point, and configure the color concentrations in the apparatus 100 using the selected color table. Additionally and/or alternatively, the formatter 115 may identify a plurality of color tables based on the identified white-point, and configure the color concentrations in the printing device by interpolating between the identified color tables. For example, if the white-point of the print material 107 is in between two or more color table values, then the formatter 115 may identify color concentrations between the two or more color table values for printing with the print material 107.

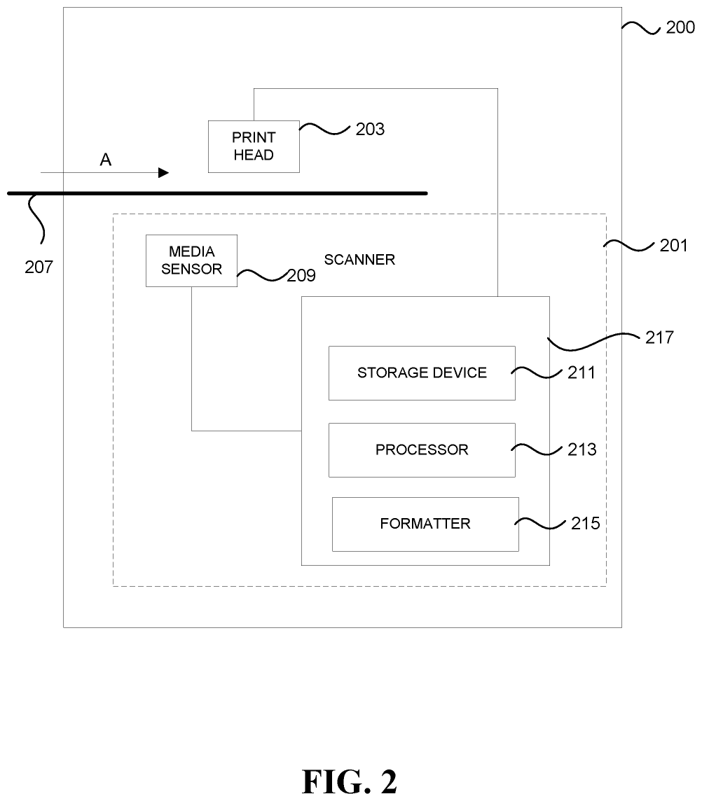

FIG. 2 further illustrates an example apparatus for configuring color concentrations based on a white-point of print material, consistent with the present disclosure. Particularly, FIG. 2 illustrates an example scanner 201. The scanner 201 may be provided within, integrated with, or connected to, a printer 200. The printer 200 may include a print head 203. The print head 203 may be arranged to print onto a print material 207, while the print material 207 is advanced along a media advance path, through the printer 200, in a media advance direction A. In some examples, two-dimensional print medium may include paper, transparent media, plastics, polyurethane, polyvinyl, etc. The print medium may further include without limitation, three-dimensional (3-D) printing materials such as acrylonitrile butadiene styrene (ABS), polylactic acid (PLA), polyvinyl alcohol (PVA), Nylon, High-density polyethylene (HDPE), polyethylene terephthalate (PETT), wood filament, metal filament, carbon fiber, flexible filament, and conductive filament, and thermal paper, among others. The print head 203 may comprise a scanning print head. The printer 200 may comprise an inkjet printer or a three-dimensional printer, among other examples. In some examples, the printer 200 may be used to scan a print material 207 to determine the white-point of the print material 207 for color calibration. For instance, a media advance drive may be to move the print material 207 along the scanner 201, and/or the print head 203. The media sensor 209 may be embedded in the printer 200 arranged along the media advance path.

In various examples, the media sensor 209 collects spectral data from light reflected off a print material. For instance, as illustrated in FIG. 1, the media sensor 209 may include a light source to illuminate a portion of the print material. The light source may, in some examples, include a linear array of RGB (red, green and blue) LEDs (Light Emitting Diodes) for shining light onto the print material 207. Additionally, and as illustrated in FIG. 1, the media sensor 209 may further include an array of photodiodes to capture light reflected off the print material 207.

As a non-limiting example, the scanner 201 may include a contact image sensor scanner, including a linear array of red, green and blue LEDs (Light Emitting Diodes) for shining light onto the print material and a sensor for recording information, as reflected by the print material.

In some examples, the scanner 201 may use a charged couple device or complementary metal oxide semiconductor type image sensor. At the end of the manufacturing stage, and during the lifetime of the scanner, color tables may be used to calibrate the scanner. By regularly calibrating the scanner, a high color accuracy of the scanner may be maintained or obtained.

In some examples, the media sensor 209 further includes a diffractor to diffract light reflected off of the print material 207, and a photo-detector to obtain the spectral data from the light reflected off the print material. For instance, referring to FIG. 1, the photo-detector 104 may include an array of photodiodes. Additionally, the diffractor 106 may include a prism. Light from light source 102 may reflect off of print material 107, pass through a slit 101, be broken into its constituent spectral colors by prism 106, and detected by photo-detector 104. In such examples, the array of photodiodes may detect an intensity of light from each spectral bin diffracted from the prism. Examples are not so limited, however, and the diffractor 106 may include other structural components with a periodic structure that splits and diffracts light into several beams travelling in different directions. For instance, the diffractor may in some examples include a diffraction grating.

In various examples, the printer 200 further includes a formatter 215 to identify a white-point of the print material using spectral data received from the media sensor, and to configure color concentrations in the printer 200 based on the identified white-point of the print material. As used herein, the spectral data refers to or includes light intensity readings collected by the media sensor 209, as well as other information collected by the media sensor 209 including media type, media thickness, media texture, and glossiness, among others. For instance, the formatter 215 may select a color table among a plurality of color tables based on the identified white-point, and configure the color concentrations in the printer 200 using the selected color table. Additionally and/or alternatively, the formatter 215 may identify a plurality of color tables based on the identified white-point, and configure the color concentrations in the printer 200 by interpolating between the identified color tables. In some examples, the formatter 215 may create a custom color table based on the white-point. Although not illustrated, the formatter 215 may in some examples retrieve the appropriate color table, based on the white-point of the media, from a network-based storage location.

The media sensor 209 may be arranged to sense media color information. This information may be used to determine media types. For example, the white points of glossy paper, matte paper and/or other types of media may vary and be associated with reflective qualities, and therefore be associated with particular and/or different color tables. In some examples, the scanner 201 may include a storage device 211 and a processor 213. The printer 200 may comprise a storage device 211 and processor 213. The printer 200 and scanner 201 may use the same or a different storage device 211 and processor 213. The processor 213 may process the color values of the medium 207, as sensed by the media sensor 209, for example an RGB value of a paper's white point. The storage device 211, processor 213, and formatter 215 may be part of a computing device 217 of the printer 200.

The storage device 211 may comprise any type of non-volatile memory. The storage device 211 may store predetermined color values and predetermined color profiles of preselected media types. For example, the storage device 211 may store predetermined white point values and predetermined color tables, for particular types of print media. In various examples, the color tables may be stored in a location external to the printer 200.

The predetermined color values may comprise a white point value of a pre-calculated color profile of a preselected medium. In this description, a “white point” may be defined as a color profile's whitest point, i.e. the color of the color space that is closest to white, although a non-printed regions of a corresponding medium does not need to be white. The color profile's white point may be approximately coincident with the unprinted medium's color. For example, a non-printed region of the medium 207 may be transparent, textured, grey, brown, green, or have any other color.

The processor 213 may be configured to compare the sensed color value with the predetermined color values stored in the storage device 211. Based on this comparison, the processor 213 may select a color table, including color concentrations to achieve a quality color print.

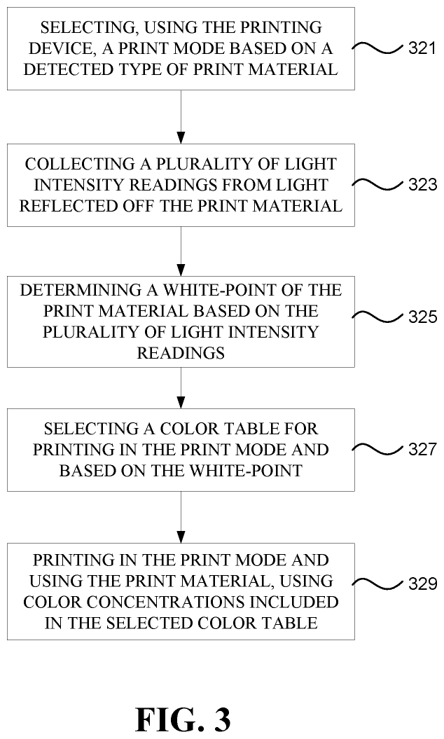

FIG. 3 illustrates an example method for configuring color concentrations based on a white-point of print material, consistent with the present disclosure. At 321 the method includes selecting, using the printing device, a print mode based on a detected type of print material used by the printing device. For instance, the media sensor may detect a type of print material, such as whether the print material is associated with two-dimensional printing or three-dimensional printing. Moreover, the media sensor may detect a size, thickness, glossiness, and texture of the print material. Based on the type of print material detected, a print mode may be selected. As a non-limiting example, one of two-dimensional printing or three-dimensional printing may be selected, based on the detected type of print material.

Using the media sensor of the printing device, a plurality of light intensity readings may be collected from light reflected off the print material, at 323. The light intensity readings may be collected by diffracting the reflected light and measuring the light intensity readings using a plurality of photo-detectors of the media sensor. For instance, as discussed with regards to FIGS. 1 and 2, the media sensor may include a light source, a diffractor, and a plurality of photo-detectors. The light source may reflect light off the print media. The reflected light may be broken up by the diffractor into a plurality of spectral bins, and detected by the plurality of photo-detectors. At 325, the white-point of the print material may be determined based on the plurality of light intensity readings. For instance, the photo-detectors may measure light intensity readings from the diffracted light. A color table for printing in the print mode and based on the white-point may be selected at 327. The light intensity readings may be used to identify a white-point of the print media, and the white-point of the print media may be used to identify a color table for color calibration. At 329 printing may be performed in the print mode and using the print material, using color concentrations included in the selected color table.

In some examples, the method includes selecting the color table based on the detected type of print material. For instance, a matte print material with a particular white-point may be associated with a different color table than a glossy print material with the same white-point. Additionally and/or alternatively, the color table may be customized based on the detected type of print material and the plurality of light intensity readings.

As an illustration, the method may include receiving a print material in a printing device, and moving the print material with respect to the printing device. The printing device may scan the print material to determine the white-point. For example, using the light source, diffractor, and photo-detectors, the printing device may scan the print material and identify the white-point of the print material. Using the determined white-point, the colors of the printing device may be calibrated by identifying a color table corresponding with the white-point of the print material.

In various examples, the printing device may automatically select a color table based on the white-point of the print media. By measuring the white-point of the print media and selecting a color table based on the measured white-point, the color concentrations of the printing device may be automatically configured. Additionally and/or alternatively, a user may manually select the color table based on the measured white-point.

The skilled artisan would recognize that various terminology as used in the Specification (including claims) connote a plain meaning in the art unless otherwise indicated. As examples, the Specification describes and/or illustrates aspects useful for implementing the claimed disclosure by way of various structure, such as circuits or circuitry selected or designed to carry out specific acts or functions, as may be recognized in the figures or the related discussion as depicted by or using terms such as blocks, and/or device, among other examples. See, e.g., reference numerals 100 and 200 of FIGS. 1 and 2. It will also be appreciated that certain of these blocks may also be used in combination to exemplify how operational aspects (e.g., steps, functions, activities, etc.) have been designed and/or arranged. Whether alone or in combination with other such blocks (or circuitry including discrete circuit elements such as transistors, resistors etc.), these above-characterized blocks may be circuits configured/coded by fixed design and/or by (re)configurable circuitry (e.g., CPUs/logic arrays/controllers) and/or circuit elements to carry out such operational aspects. In certain examples, such a programmable circuit refers to or includes one or more computer circuits, including memory circuitry for storing and accessing a set of program code to be accessed/executed as instructions and/or (re)configuration data to perform the related operation, as may be needed in the form of carrying out a single step or a more complex multi-step algorithm. Depending on the data-processing application, such instructions (and/or configuration data) can be configured for implementation in logic circuitry, with the instructions (via fixed circuitry, limited group of configuration code, or instructions characterized by way of object code and/or software) as may be stored in and accessible from a memory (circuit).

Based upon the above discussion and illustrations, those skilled in the art will readily recognize that various modifications and changes may be made to the various examples without strictly following the exemplary examples and applications illustrated and described herein. For example, methods as exemplified in the Figures may involve steps carried out in various orders, with one or more aspects of the examples herein retained, or may involve fewer or more steps. Such modifications do not depart from the true spirit and scope of various aspects of the disclosure, including aspects set forth in the claims.

What is claimed is:

1. An apparatus including:
a media sensor to collect spectral data from light reflected off a print material, wherein the media sensor includes:
a light source to illuminate a portion of the print material;
a diffractor to diffract light reflected off of the print material; and
a photo-detector to obtain the spectral data from the light reflected off the print material; and
a formatter to identify a white-point of the print material using the spectral data and configure color concentrations in the apparatus based on the identified white-point of the print material.

2. The apparatus of claim 1, wherein the photo-detector includes an array of photodiodes.

3. The apparatus of claim 2, wherein the diffractor includes a prism, the array of photodiodes to detect an intensity of light from each spectral bin diffracted from the prism.

4. The apparatus of claim 1, wherein the diffractor includes a diffraction grating.

5. The apparatus of claim 1, the formatter to select a color table among a plurality of color tables based on the identified white-point, and configure the color concentrations in the apparatus using the selected color table.

6. The apparatus of claim 1, the formatter to identify a plurality of color tables based on the identified white-point, and configure the color concentrations in the printing device by interpolating between the identified color tables.

7. An apparatus including:
a media sensor to determine a type of print material used by the apparatus and to collect a plurality of light intensity readings from light reflected off the print material, wherein the media sensor includes:
a light source to illuminate a portion of the print material;
a diffractor to diffract light reflected off of the print material; and
a photo-detector to obtain the plurality of light intensity readings from the light reflected off the print material; and
a formatter to identify a white-point of the print material using the plurality of light intensity readings and to configure color concentrations in the apparatus based on the identified white-point of the print material.

8. The apparatus of claim 7, wherein responsive to the media sensor determining the print material is a three-dimensional printing substance, the formatter is to identify the white-point of the three-dimensional printing substance.

9. The apparatus of claim 8, further including the formatter to retrieve from a network-accessible table, a color table including the color concentrations to be applied to the three-dimensional printing substance, based on the identified white-point.

10. The apparatus of claim 8, further including the formatter to generate a customized color table including the color concentrations to be applied to the three-dimensional printing substance, based on the identified white-point.

11. The apparatus of claim 7, wherein responsive to the media sensor determining the print material is a two-dimensional printing surface, the formatter is to identify the white-point of the two-dimensional printing surface.

12. The apparatus of claim 11, further including the formatter to retrieve from a network-accessible table, a color table including the color concentrations to be applied to ink printed on the two-dimensional printing surface, based on the identified white-point.

13. A method for white-point correction in a printing device, comprising:
selecting, using the printing device, a print mode based on a detected type of print material used by the printing device;
collecting, using a media sensor of the printing device, a plurality of light intensity readings from light reflected off the print material, by diffracting the reflected light and measuring the light intensity readings using a plurality of photo-detectors of the media sensor;
determining a white-point of the print material based on the plurality of light intensity readings;
selecting a color table for printing in the print mode and based on the white-point; and
printing in the print mode and using the print material, using color concentrations included in the selected color table.

14. The method of claim 13, including selecting the color table based on the detected type of print material.

15. The method of claim 13, including customizing the color table based on the detected type of print material and the plurality of light intensity readings.
